(19) United States
(12) Patent Application Publication
(10) Pub. No.: US 2026/0359394 A1
(43) Pub. Date: Nov. 12, 2026

(54) SYSTEMS AND METHODS FOR GENERATING SPARSE SIGN SKETCHES WITH REJECTION SAMPLING

(71) Applicant: JPMORGAN CHASE BANK, N.A., New York, NY (US)

(72) Inventors: Niraj KUMAR, Amsterdam (NL); Tyler CHEN, New York, NY (US); Marco PISTOIA, New York, NY (US)

(21) Appl. No.: 19/669,302

(22) Filed: May 6, 2026

Related U.S. Application Data
(60) Provisional application No. 63/802,908, filed on May 9, 2025.

(51) Int. Cl. G06F 17/40; G06F 7/24

(52) U.S. Cl. CPC G06F 17/40; G06F 7/24

(57) ABSTRACT

Systems and methods for generating sparse sign sketches with rejection sampling are disclosed. In an embodiment, a method may include: randomly sampling, by a computer program executed by an electronic device, a list of integers from a dataset using a sparsity parameter; sorting, by the computer program, the list of integers; identifying, by the computer program, duplicate integers in the sorted list of integers; replacing, by the computer program, the duplicates integers with independent samples drawn uniformly at random from the dataset, resulting in an updated list of integers; and repeating, by the computer program, the sorting, identifying, and replacing until there are no duplicate integers in the updated list of integers.

### RELATED APPLICATIONS

This application claims priority to U.S. Provisional Patent Application Ser. No. 63/802,908, filed May 9, 2025, the disclosure of which is hereby incorporated, by reference, in its entirety.

### BACKGROUND OF THE INVENTION

### 1. Field of the Invention

Embodiments relate to systems and methods for generating sparse sign sketches with rejection sampling.

### 2. Description of the Related Art

Many modern data-intensive tasks (such as clustering, regression, low-rank approximation, etc.) require applying algorithms to huge amounts of data. Often this data is very high-dimensional. These tasks can be significantly accelerated by reducing the dimension of the input data while approximately preserving key properties (e.g., the distance between data points). One promising general-purpose dimension reduction technique is sketching. Sketching preserves the “right properties” for many linear algebra tasks (such as linear regression and low-rank approximation), and involves generating a (typically random) sketching matrix, and applying this matrix to the data.

For example, if A is a m rows×n columns data matrix, a sketching matrix S is a d rows×m column matrix (where d is ideally much less than m), and the dimension reduced data matrix is SA (where SA is the matrix product of S and A).

There are many different choices of sketching matrices, including sparse sign sketching. Sparse sign sketching is disclosed in, for example, Xiangrui Meng and Michael W. Mahoney, “Low-Distortion Subspace Embeddings in Input-Sparsity Time and Applications to Robust Linear Regression,” Proceedings of the Forty-Fifth Annual ACM Symposium on Theory of Computing. STOC '13. Palo Alto, California, USA: Association for Computing Machinery, 2013, pp. 91-100 (available at doi.org/10.1145/2488608.2488621), Kenneth L. Clarkson and David P. Woodruff, “Low rank approximation and regression in input sparsity time” Proceedings of the forty-fifth annual ACM Symposium on Theory of Computing STOC '13. ACM, June 2013 (available at dx.doi.org/10.1145/2488608.2488620; Jelani Nelson and Huy L. Nguyen, “Lower Bounds for Oblivious Subspace Embeddings” Automata, Languages, and Programming. Springer Berlin Heidelberg, 2014, pp. 883-894 (available at dx.doi.org/10.1007/978-3-662-43948-7_73; David P. Woodruff, “Sketching as a Tool for Numerical Linear Algebra” Found. Trends Theor. Comput. Sci. 10.1-2 (October 2014) (available at doi.org/10.1561/0400000060); and Joel A. Tropp et al., “Streaming Low-Rank Matrix Approximation with an Application to Scientific Simulation”. Vol. 41. 4. Society for Industrial & Applied Mathematics (SIAM), January 2019, A2430-63 (available at dx.doi.org/10.1137/18M1201068.). The disclosure of each of these documents is hereby incorporated, by reference, in its entirety.

For example, a d×m matrix S (d rows and m columns) is a sparse-sign sketching matrix with sparsity parameter ζ if:

$$s = \sqrt{\frac{m}{ζ}} [ {s}_{1} {s}_{2} ⋯ {s}_{m} ]$$

where each column sᵢ is independent and consists of exactly ζ random signs situated in uniformly random coordinates.

Sparse sign sketches are efficient to generate and apply. In particular, S can be generated in O(ζm) time and SA can be computed in O(ζ nnz(A)) time, where nnz(A) is the number of nonzero entries in A. This is substantially faster than O(dm) and O(d nnz(A)) times, respectively, required to generate and apply a dense sketching matrix. Moreover, since the columns of S are independent, the sketch S can easily be generated and applied in parallel. This is particularly relevant to using GPUs, which well-suited for such tasks.

### SUMMARY OF THE INVENTION

Systems and methods for generating sparse sign sketches with rejection sampling are disclosed. In an embodiment, a method may include: randomly sampling, by a computer program executed by an electronic device, a list of integers from a dataset using a sparsity parameter; sorting, by the computer program, the list of integers; identifying, by the computer program, duplicate integers in the sorted list of integers; replacing, by the computer program, the duplicates integers with independent samples drawn uniformly at random from the dataset, resulting in an updated list of integers; and repeating, by the computer program, the sorting, identifying, and replacing until there are no duplicate integers in the updated list of integers.

In an embodiment, the list of integers are sampled from a plurality of columns in the dataset.

In an embodiment, the list of integers are sampled from the plurality of columns in parallel using a graphics processing unit.

In an embodiment, the duplicate integers comprise neighbors in the sorted list of integers.

In an embodiment, the method may also include: adjusting, by the computer program, the sparsity parameter in response to an insufficient number of unique integers being in the updated list of integers.

In an embodiment, the method may also include: populating, by the computer program, a column of a matrix C with the updated list of integers; and repeating the sampling, sorting, identifying, replacing, repeating, and populating for all columns in the dataset.

In an embodiment, the method may also include: generating, by the computer program, a matrix of random signs; and generating, by the computer program, a sparse sketch from the matrix C and the matrix of random signs.

According to another embodiment, a non-transitory computer readable storage medium may include instructions stored thereon, which when read and executed by one or more computer processors, cause the one or more computer processors to perform steps comprising: randomly sampling a list of integers from a dataset using a sparsity parameter; sorting the list of integers; identifying duplicate integers in the sorted list of integers; replacing the duplicates integers with independent samples drawn uniformly at random from the dataset, resulting in an updated list of integers; and repeating the sorting, identifying, and replacing until there are no duplicate integers in the updated list of integers.

In an embodiment, the list of integers are sampled from a plurality of columns in the dataset.

In an embodiment, one of the computer processors may include a graphical processing unit, and the list of integers are sampled from the plurality of columns in parallel.

In an embodiment, the duplicate integers comprise neighbors in the sorted list of integers.

In an embodiment, the non-transitory computer readable storage medium may also include instructions stored thereon, which when read and executed by the one or more computer processors, cause the one or more computer processors to perform steps comprising: adjusting the sparsity parameter in response to an insufficient number of unique integers being in the updated list of integers.

In an embodiment, the non-transitory computer readable storage medium may also include instructions stored thereon, which when read and executed by the one or more computer processors, cause the one or more computer processors to perform steps comprising: populating a column of a matrix C with the updated list of integers; and repeating the sampling, sorting, identifying, replacing, repeating, and populating for all columns in the dataset.

In an embodiment, the non-transitory computer readable storage medium may also include instructions stored thereon, which when read and executed by the one or more computer processors, cause the one or more computer processors to perform steps comprising: generating a matrix of random signs; and generating a sparse sketch from the matrix C and the matrix of random signs.

According to another embodiment, a system may include: a data source; and an electronic device comprising a computer processor and configured to randomly sample a list of integers from a dataset in the data source using a sparsity parameter; to sort the list of integers; to identify duplicate integers in the sorted list of integers; to replace the duplicates integers with independent samples drawn uniformly at random from the dataset, resulting in an updated list of integers; and to repeat the sorting, identifying, and replacing until there are no duplicate integers in the updated list of integers.

In an embodiment, the list of integers are sampled from a plurality of columns in the dataset.

In an embodiment, the computer processor may include a graphical processing unit, and the list of integers are sampled from the plurality of columns in parallel.

In an embodiment, the electronic device may be further configured to adjust the sparsity parameter in response to an insufficient number of unique integers being in the updated list of integers.

In an embodiment, the electronic device may be further configured to populating a column of a matrix C with the updated list of integers, and to repeat the sampling, sorting, identifying, replacing, repeating, and populating for all columns in the dataset.

In an embodiment, the electronic device may be further configured to generate a matrix of random signs; and to generate a sparse sketch from the matrix C and the matrix of random signs.

### BRIEF DESCRIPTION OF THE DRAWINGS

For a more complete understanding of the present invention, the objects and advantages thereof, reference is now made to the following descriptions taken in connection with the accompanying drawings in which:

FIG. 1 illustrates a system for generating sparse sign sketches with rejection sampling according to an embodiment;

FIG. 2 illustrates a method for generating sparse sign sketches with rejection sampling according to an embodiment;

FIG. 3 depicts an exemplary computing system for implementing aspects of the present disclosure.

### DETAILED DESCRIPTION OF PREFERRED EMBODIMENTS

Embodiments relate to systems and methods for generating sparse sign sketches with rejection sampling. This may be used to solve least squares regression problems.

In one embodiment, parameters for the sparse sign sketch may be based on the problem being solved.

In one embodiment, matrix S may be generated column by column. To generate a column of S, the nonzero entries must be known. By definition, exactly ζ entries of each column of S are nonzero, and these are in uniformly random positions. The values of each of the nonzero entries is

$$either + \sqrt{\frac{m}{ζ}} or - \sqrt{\frac{m}{ζ}} ,$$

each with equal probability.

Thus, embodiments determine which of the entries of the column should be nonzero. There are d columns, so this is equivalent to picking exactly ζ numbers from the list [d]={1, 2, . . . , d} in a fair way).

In the context of building a sparse sign sketching matrix, the process may be repeated m times; i.e., for every column of S or equivalently for every data-point in A. In big-data settings m may be very large—billions or trillions, or more). Embodiments provide an efficient method that reduces practical costs such as energy usage, wall-clock time, expense for rented compute resources, etc.

The disclosure of “GPU-Parallelizable Randomized Sketch-and-Precondition for Linear Regression using Sparse Sign Sketches” to Chen et al., available at arXiv:2506.03070v1, is hereby incorporated, by reference, in its entirety.

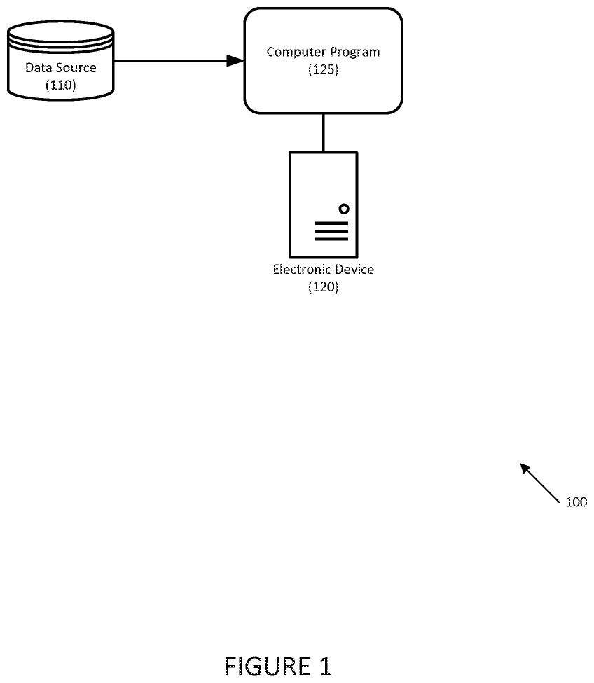

FIG. 1 depicts a system for generating sparse sign sketches with rejection sampling according to an embodiment. System 100 may include data source 110 and electronic device 120. Data source 110 may include any sort of data, including tables of data. The data may vary depending on the application that the data is used for.

Electronic device 120 may be any suitable electronic device, including servers, computers, smart devices, etc. Electronic device 120 may execute computer program 125, which may generate a sparse sign sketch of data in data source 110 with rejection sampling.

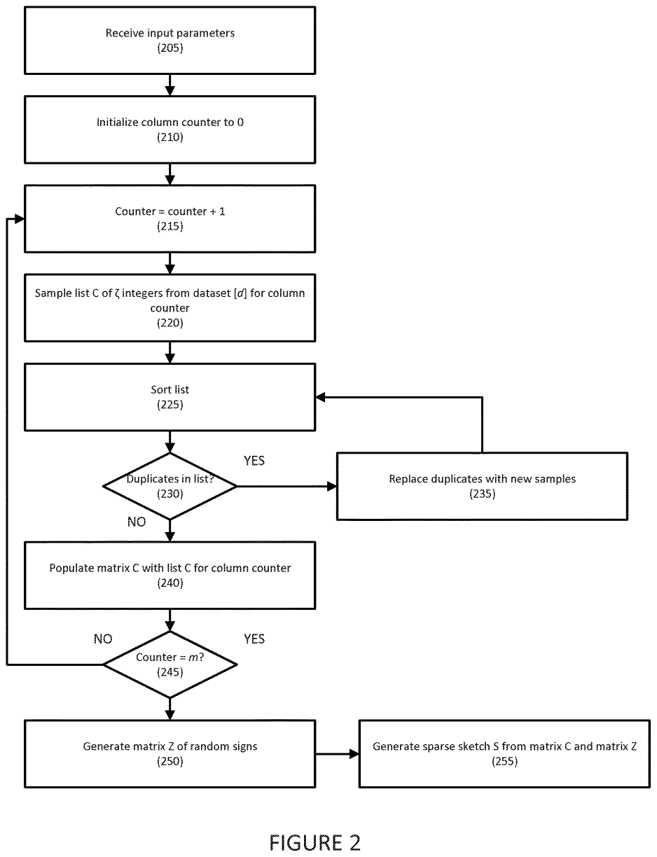

FIG. 2 depicts a method for generating sparse sign sketches with rejection sampling according to an embodiment.

In step 205, a computer program may receive input parameters. The input parameters may include a number of rows (d) and a number of columns (m) for a dataset (e.g., a table), as well as a sparsity parameter (ζ) that specifies the number of unique integers to draw. If the end goal is generating sparse sign sketch S, ζ is the number of non-zeros per column of S. If ζ=1, then S will have exactly 1 nonzero per column and is a very sparse representation of the column (e.g., only one value from the column is sampled). ζ can be as large as d, which is the total number of rows in S in which case it would not be a sparse representation of the column (e.g., it will have all values from the original dataset).

In step 210, the computer program may initialize a column counter to 0, and in step 215, may increase the column counter by 1 so that each column may be processed individually.

Note embodiments may use single instruction multiple data (SIMD) processing so that the columns may be processed in parallel. Thus, although the flow illustrates an iterative process in which the columns are processed sequentially, multiple columns may be processed in parallel on, for example, a GPU. In one embodiment, all columns may be processed simultaneously in parallel.

In step 220, the computer program may randomly sample a list C of ζ integers from a column associated with the column counter (e.g., column counter=1, column=1; column counter 2=column 2; etc.). The number of integers sampled is based on the sparsity parameter ζ.

In step 225, the computer program may sort list C to identify duplicates. List C may be sorted in any suitable manner, e.g., ascending or descending.

In step 230, the computer program may check to see if there are duplicates in list C. Due to the sorting, the duplicates will be neighbors.

If there are, in step 235, the duplicates may be replaced with new independent samples drawn uniformly at random from the dataset. Thus, each integer in the column has an equal probability of being selected.

Steps 225, 230, and 235 may be repeated until all entries in list C are unique. If there are not enough unique numbers, the sparsity parameter may be adjusted. Because the sparsity parameter is typically much less than d, this is unlikely to occur.

In step 240, the list C of unique integers may be used to populate the corresponding column in matrix C. Matrix C may be a matrix of the sampled integers that is ζ rows by d columns.

In step 245, if the column counter equals m (i.e., all columns of the dataset have been processed), the result is matrix C.

If all columns have not been processed, the flow may return to step 215.

In step 250, the computer program may generate a matrix Z of random signs that is ζ rows by d columns. The signs (positive or negative) may be randomly selected. Matrix Z may be used with matrix C to generate the sparse sign sketch S.

In step 255, the computer program may implement a software library to generate sparse sketch S from matrix C and matrix Z. An example of such is disclosed in Appendix A.2, “Technical Report No. UCB/EECS-2023-19” (2023) available at www2.eecs.berkeley.edu/Pubs/TechRpts/2023/EECS-2023-19, the disclosure of which is hereby incorporated, by reference, in its entirety.

Since the distribution of the number of repeated entries in the first draw has an extremely light tail (e.g., a low probability of a large number of repeated entries), embodiments may only resample duplicate entries, which is more efficient than resampling all entries. Even if the entire column were redrawn, rejection sampling would still be efficient.

In particular, let p be the probability that a sample of ζ numbers drawn uniformly at random from dataset [d] with replacement contains no repeats. Bounding may be performed as follows:

$$p = \frac{d}{d} \frac{d - 1}{d} … \frac{d - ( ζ - 1 )}{d} \geq ( 1 - \frac{ζ}{d} ) \geq 1 - \frac{{ζ}^{2}}{d}$$

This equation shows that the probability of success is close to 1 (which means that it is usually successful). Bound means to give a “lower bound” which is a minimum possible value for the probability. It is similar to an estimate, but there is no uncertainty.

The theoretical guarantees for sparse sign sketches require ζ=O(log(n)) and d=O(n log(n)), and ζ=O(1) and d=O(n) are often used in practice. In such cases, p=1−Õ(n⁻¹), so since n>>1, rejection sampling is efficient.

Another practical benefit from the embodiments is leveraging high-level primitives such as sorting and array-wise comparison. As such, this approach is naturally able to take advantage of any system-specific optimizations from existing libraries. A basic CuPy/SciPy implementation of this approach is given in the algorithm below:

def sparse_sketch(d,m,zeta):
# generate random row-indices with replacement
C = random.randint(0,d, size=(m,zeta))
# sort indices within columns
C.sort(axis=1)
# search for duplicates within columns and identify bad columns
bad_idxs_i,bad_idxs_j = where(C[:, 1:] == C[:, :−1])
n_bad_idxs = len(bad_idxs_j)
bad_cols = unique(bad_idxs_i)
#rejection sampling
while n_bad_idxs > 0:
# regenerate random row-indices for duplicates
C[bad_idxs_i,bad_idxs_j] = random.randint(d,size-(n_bad_idxs))
# sort indices (but only in bad columns)
C[bad_cols] = sort(C[bad_cols],axis=1)
# search for duplicates (but only in bad columns)
bad_idxs_i,bad_idxs_j = where(C[bad_cols, 1:] == C[bad_cols, :−1])
bad_idxs_i = bad_cols[bad_idxs_i] # convert to global indices
n_bad_idxs = len(bad_idxs_j)
bad_cols = unique(bad_idxs_i)
# random (normalized) signs
values = ((2/sqrt(zeta))*random.randint(2,size=m*zeta)−1/sqrt(zeta)
# build CSC matrix
indices = C.flatten( )
indptr = arange(0,m+1)*zeta
S = sparse.csc_matrix((values,indices,indptr), shape=(d,m))
return S

The preconditioner M is the inverse of an upper triangular matrix R. Thus, the preconditioner may apply x [symbol] Mx may be computed by solving a linear system with R, an O(n²) operation. M=R⁻¹ may be formed by inverting R. This incurs a single O(n³) cost, and subsequent applies are then O(n²). However, matrix vector products are far more optimized than back-substitution, resulting in some speed gains.

As noted above, embodiments may use multiple GPUs for parallelization. Matrix A (a m rows×n columns data matrix) may be extremely large and tall (m>>n>>1). As such, algorithms are naturally parallelized by distributing any operations involving length-m vectors. In particular, given p GPU devices, {1, 2, . . . , m} may be partitioned into sets of indices I₁, I₂, . . . , Iₚ and the corresponding rows of (tall) matrices and vectors may be distributed to each GPU device. The entire problem may be distributed once and the corresponding parts stored in local GPU memory.

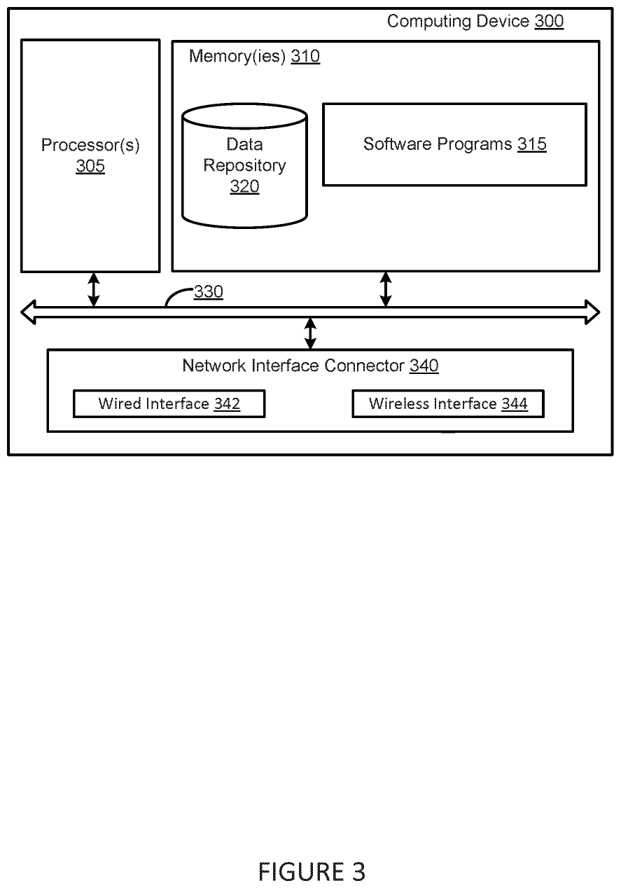

FIG. 3 depicts an exemplary computing system for implementing aspects of the present disclosure. FIG. 3 depicts exemplary computing device 300. Computing device 300 may represent the system components described herein. Computing device 300 may include processor 305 that may be coupled to memory 310. Memory 310 may include volatile memory. Processor 305 may execute computer-executable program code stored in memory 310, such as software programs 315. Software programs 315 may include one or more of the logical steps disclosed herein as a programmatic instruction, which may be executed by processor 305. Memory 310 may also include data repository 320, which may be nonvolatile memory for data persistence. Processor 305 and memory 310 may be coupled by bus 330. Bus 330 may also be coupled to one or more network interface connectors 340, such as wired network interface 342 or wireless network interface 344. Computing device 300 may also have user interface components, such as a screen for displaying graphical user interfaces and receiving input from the user, a mouse, a keyboard and/or other input/output components (not shown).

Although several embodiments have been disclosed, it should be recognized that these embodiments are not exclusive to each other, and features from one embodiment may be used with others.

Hereinafter, general aspects of implementation of the systems and methods of embodiments will be described.

Embodiments of the system or portions of the system may be in the form of a “processing machine,” such as a general-purpose computer, for example. As used herein, the term “processing machine” is to be understood to include at least one processor that uses at least one memory. The at least one memory stores a set of instructions. The instructions may be either permanently or temporarily stored in the memory or memories of the processing machine. The processor executes the instructions that are stored in the memory or memories in order to process data. The set of instructions may include various instructions that perform a particular task or tasks, such as those tasks described above. Such a set of instructions for performing a particular task may be characterized as a program, software program, or simply software.

In one embodiment, the processing machine may be a specialized processor.

In one embodiment, the processing machine may be a cloud-based processing machine, a physical processing machine, or combinations thereof.

As noted above, the processing machine executes the instructions that are stored in the memory or memories to process data. This processing of data may be in response to commands by a user or users of the processing machine, in response to previous processing, in response to a request by another processing machine and/or any other input, for example.

As noted above, the processing machine used to implement embodiments may be a general-purpose computer. However, the processing machine described above may also utilize any of a wide variety of other technologies including a special purpose computer, a computer system including, for example, a microcomputer, mini-computer or mainframe, a programmed microprocessor, a micro-controller, a peripheral integrated circuit element, a CSIC (Customer Specific Integrated Circuit) or ASIC (Application Specific Integrated Circuit) or other integrated circuit, a logic circuit, a digital signal processor, a programmable logic device such as a FPGA (Field-Programmable Gate Array), PLD (Programmable Logic Device), PLA (Programmable Logic Array), or PAL (Programmable Array Logic), or any other device or arrangement of devices that is capable of implementing the steps of the processes disclosed herein.

The processing machine used to implement embodiments may utilize a suitable operating system.

It is appreciated that in order to practice the method of the embodiments as described above, it is not necessary that the processors and/or the memories of the processing machine be physically located in the same geographical place. That is, each of the processors and the memories used by the processing machine may be located in geographically distinct locations and connected so as to communicate in any suitable manner. Additionally, it is appreciated that each of the processor and/or the memory may be composed of different physical pieces of equipment. Accordingly, it is not necessary that the processor be one single piece of equipment in one location and that the memory be another single piece of equipment in another location. That is, it is contemplated that the processor may be two pieces of equipment in two different physical locations. The two distinct pieces of equipment may be connected in any suitable manner. Additionally, the memory may include two or more portions of memory in two or more physical locations.

To explain further, processing, as described above, is performed by various components and various memories. However, it is appreciated that the processing performed by two distinct components as described above, in accordance with a further embodiment, may be performed by a single component. Further, the processing performed by one distinct component as described above may be performed by two distinct components.

In a similar manner, the memory storage performed by two distinct memory portions as described above, in accordance with a further embodiment, may be performed by a single memory portion. Further, the memory storage performed by one distinct memory portion as described above may be performed by two memory portions.

Further, various technologies may be used to provide communication between the various processors and/or memories, as well as to allow the processors and/or the memories to communicate with any other entity; i.e., so as to obtain further instructions or to access and use remote memory stores, for example. Such technologies used to provide such communication might include a network, the Internet, Intranet, Extranet, a LAN, an Ethernet, wireless communication via cell tower or satellite, or any client server system that provides communication, for example. Such communications technologies may use any suitable protocol such as TCP/IP, UDP, or OSI, for example.

As described above, a set of instructions may be used in the processing of embodiments. The set of instructions may be in the form of a program or software. The software may be in the form of system software or application software, for example. The software might also be in the form of a collection of separate programs, a program module within a larger program, or a portion of a program module, for example. The software used might also include modular programming in the form of object-oriented programming. The software tells the processing machine what to do with the data being processed.

Further, it is appreciated that the instructions or set of instructions used in the implementation and operation of embodiments may be in a suitable form such that the processing machine may read the instructions. For example, the instructions that form a program may be in the form of a suitable programming language, which is converted to machine language or object code to allow the processor or processors to read the instructions. That is, written lines of programming code or source code, in a particular programming language, are converted to machine language using a compiler, assembler or interpreter. The machine language is binary coded machine instructions that are specific to a particular type of processing machine, i.e., to a particular type of computer, for example. The computer understands the machine language.

Any suitable programming language may be used in accordance with the various embodiments. Also, the instructions and/or data used in the practice of embodiments may utilize any compression or encryption technique or algorithm, as may be desired. An encryption module might be used to encrypt data. Further, files or other data may be decrypted using a suitable decryption module, for example.

As described above, the embodiments may illustratively be embodied in the form of a processing machine, including a computer or computer system, for example, that includes at least one memory. It is to be appreciated that the set of instructions, i.e., the software for example, that enables the computer operating system to perform the operations described above may be contained on any of a wide variety of media or medium, as desired. Further, the data that is processed by the set of instructions might also be contained on any of a wide variety of media or medium. That is, the particular medium, i.e., the memory in the processing machine, utilized to hold the set of instructions and/or the data used in embodiments may take on any of a variety of physical forms or transmissions, for example. Illustratively, the medium may be in the form of a compact disc, a DVD, an integrated circuit, a hard disk, a floppy disk, an optical disc, a magnetic tape, a RAM, a ROM, a PROM, an EPROM, a wire, a cable, a fiber, a communications channel, a satellite transmission, a memory card, a SIM card, or other remote transmission, as well as any other medium or source of data that may be read by the processors.

Further, the memory or memories used in the processing machine that implements embodiments may be in any of a wide variety of forms to allow the memory to hold instructions, data, or other information, as is desired. Thus, the memory might be in the form of a database to hold data. The database might use any desired arrangement of files such as a flat file arrangement or a relational database arrangement, for example.

In the systems and methods, a variety of “user interfaces” may be utilized to allow a user to interface with the processing machine or machines that are used to implement embodiments. As used herein, a user interface includes any hardware, software, or combination of hardware and software used by the processing machine that allows a user to interact with the processing machine. A user interface may be in the form of a dialogue screen for example. A user interface may also include any of a mouse, touch screen, keyboard, keypad, voice reader, voice recognizer, dialogue screen, menu box, list, checkbox, toggle switch, a pushbutton or any other device that allows a user to receive information regarding the operation of the processing machine as it processes a set of instructions and/or provides the processing machine with information. Accordingly, the user interface is any device that provides communication between a user and a processing machine. The information provided by the user to the processing machine through the user interface may be in the form of a command, a selection of data, or some other input, for example.

As discussed above, a user interface is utilized by the processing machine that performs a set of instructions such that the processing machine processes data for a user. The user interface is typically used by the processing machine for interacting with a user either to convey information or receive information from the user. However, it should be appreciated that in accordance with some embodiments of the system and method, it is not necessary that a human user actually interact with a user interface used by the processing machine. Rather, it is also contemplated that the user interface might interact, i.e., convey and receive information, with another processing machine, rather than a human user. Accordingly, the other processing machine might be characterized as a user. Further, it is contemplated that a user interface utilized in the system and method may interact partially with another processing machine or processing machines, while also interacting partially with a human user.

It will be readily understood by those persons skilled in the art that embodiments are susceptible to broad utility and application. Many embodiments and adaptations of the present invention other than those herein described, as well as many variations, modifications and equivalent arrangements, will be apparent from or reasonably suggested by the foregoing description thereof, without departing from the substance or scope.

Accordingly, while the embodiments of the present invention have been described here in detail in relation to its exemplary embodiments, it is to be understood that this disclosure is only illustrative and exemplary of the present invention and is made to provide an enabling disclosure of the invention. Accordingly, the foregoing disclosure is not intended to be construed or to limit the present invention or otherwise to exclude any other such embodiments, adaptations, variations, modifications, or equivalent arrangements.

What is claimed is:

1. A method, comprising:
randomly sampling, by a computer program executed by an electronic device, a list of integers from a dataset using a sparsity parameter;
sorting, by the computer program, the list of integers;
identifying, by the computer program, duplicate integers in the sorted list of integers;
replacing, by the computer program, the duplicates integers with independent samples drawn uniformly at random from the dataset, resulting in an updated list of integers; and
repeating, by the computer program, the sorting, identifying, and replacing until there are no duplicate integers in the updated list of integers.

2. The method of claim 1, wherein the list of integers are sampled from a plurality of columns in the dataset.

3. The method of claim 2, wherein the list of integers are sampled from the plurality of columns in parallel using a graphics processing unit.

4. The method of claim 1, wherein the duplicate integers comprise neighbors in the sorted list of integers.

5. The method of claim 1, further comprising:
adjusting, by the computer program, the sparsity parameter in response to an insufficient number of unique integers being in the updated list of integers.

6. The method of claim 1, further comprising:
populating, by the computer program, a column of a matrix C with the updated list of integers; and
repeating the sampling, sorting, identifying, replacing, repeating, and populating for all columns in the dataset.

7. The method of claim 6, further comprising:
generating, by the computer program, a matrix of random signs; and
generating, by the computer program, a sparse sketch from the matrix C and the matrix of random signs.

8. A non-transitory computer readable storage medium, including instructions stored thereon, which when read and executed by one or more computer processors, cause the one or more computer processors to perform steps comprising:
randomly sampling a list of integers from a dataset using a sparsity parameter;
sorting the list of integers;
identifying duplicate integers in the sorted list of integers;
replacing the duplicates integers with independent samples drawn uniformly at random from the dataset, resulting in an updated list of integers; and
repeating the sorting, identifying, and replacing until there are no duplicate integers in the updated list of integers.

9. The non-transitory computer readable storage medium of claim 8, wherein the list of integers are sampled from a plurality of columns in the dataset.

10. The non-transitory computer readable storage medium of claim 9, wherein one of the computer processors comprises a graphical processing unit, and the list of integers are sampled from the plurality of columns in parallel.

11. The non-transitory computer readable storage medium of claim 8, wherein the duplicate integers comprise neighbors in the sorted list of integers.

12. The non-transitory computer readable storage medium of claim 8, further including instructions stored thereon, which when read and executed by the one or more computer processors, cause the one or more computer processors to perform steps comprising:
adjusting the sparsity parameter in response to an insufficient number of unique integers being in the updated list of integers.

13. The non-transitory computer readable storage medium of claim 8, further including instructions stored thereon, which when read and executed by the one or more computer processors, cause the one or more computer processors to perform steps comprising:
populating a column of a matrix C with the updated list of integers; and
repeating the sampling, sorting, identifying, replacing, repeating, and populating for all columns in the dataset.

14. The non-transitory computer readable storage medium of claim 13, further including instructions stored thereon, which when read and executed by the one or more computer processors, cause the one or more computer processors to perform steps comprising:
generating a matrix of random signs; and
generating a sparse sketch from the matrix C and the matrix of random signs.

15. A system, comprising:
a data source; and
an electronic device comprising a computer processor and configured to randomly sample a list of integers from a dataset in the data source using a sparsity parameter; to sort the list of integers; to identify duplicate integers in the sorted list of integers; to replace the duplicates integers with independent samples drawn uniformly at random from the dataset, resulting in an updated list of integers; and to repeat the sorting, identifying, and replacing until there are no duplicate integers in the updated list of integers.

16. The system of claim 15 wherein the list of integers are sampled from a plurality of columns in the dataset.

17. The system of claim 16, wherein the computer processor comprises a graphical processing unit, and the list of integers are sampled from the plurality of columns in parallel.

18. The system of claim 15, wherein the electronic device is further configured to adjust the sparsity parameter in response to an insufficient number of unique integers being in the updated list of integers.

19. The system of claim 15, wherein the electronic device is further configured to populating a column of a matrix C with the updated list of integers, and to repeat the sampling, sorting, identifying, replacing, repeating, and populating for all columns in the dataset.

20. The system of claim 19, wherein the electronic device is further configured to generate a matrix of random signs; and to generate a sparse sketch from the matrix C and the matrix of random signs.
